(19) United States
(12) Patent Application Publication
(10) Pub. No.: US 2017/0341978 A1
(43) Pub. Date: Nov. 30, 2017

(54) METHOD AND APPARATUS FOR RESIN FILM INFUSION

(71) Applicant: GENERAL PLASTICS & COMPOSITES, L.P., Houston, TX (US)

(72) Inventor: Jarrad ZAISER, Missouri City, TX (US)

(73) Assignee: GENERAL PLASTICS & COMPOSITES, L.P., Houston, TX (US)

(21) Appl. No.: 15/680,044

(22) Filed: Aug. 17, 2017

Related U.S. Application Data
(63) Continuation-in-part of application No. 15/431,455, filed on Feb. 13, 2017.
Application No. 15/431,455 is a continuation of application No. 14/018,925, filed on Sep. 5, 2013, now abandoned.
(60) Provisional application No. 61/698,038, filed on Sep. 7, 2012.

(51) Int. Cl. C03C 25/14; B29C 53/66; C03C 25/32

(52) U.S. Cl. CPC C03C 25/14; C03C 25/326; C03C 25/323; C03C 25/143; B29C 53/66; Y10T 428/2933; Y10T 428/1352

(57) ABSTRACT

A filament winding method and system without needing a resin dip bath are disclosed. The method comprises feeding a fiber band of a plurality of fibers onto a mandrel without dipping the fibers in a resin bath, and applying a resin onto the fiber band at or about where the fiber band contacts the mandrel or applied directly to the fiber band and then wound onto the mandrel so that the resin is between the mandrel and the fiber band at the point of contact. In some embodiments, the resin can be sprayed onto the fibers and in other embodiments, the resin can be delivered in at least one layer onto the fiber band that is then impregnated into the fiber band as the fiber band wraps around the mandrel. The fiber can comprise carbon fiber, basalt fiber, glass fibers, Kevlar fiber, polyester fiber, other fibers, or a combination thereof.

### CROSS REFERENCE TO RELATED APPLICATIONS

This application is a continuation-in-part of U.S. Ser. No. 15/431,455, filed Feb. 13, 2017, which is a continuation of U.S. Ser. No. 14/018,925, filed Sep. 5, 2013, which claims the benefit of U.S. Provisional No. 61/698,038, filed Sep. 7, 2012, the disclosures of which are hereby incorporated herein by reference.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

### Field of the Invention

This invention relates generally to the field of filament winding. More specifically, this invention relates to method and apparatus for resin film infusion during a filament winding process.

### Description of the Related Art

Filament winding is a fabrication technique for manufacturing composite material, usually in the form of cylindrical structures. The process involves winding filaments under varying amounts of tension over a male mould or mandrel. The mandrel rotates while a carriage moves horizontally (x direction as shown in FIG. 3, laying down fibers in the desired pattern.

The most common filaments are carbon or glass fiber and are coated with thermoset resin as they are wound. Once the mandrel is completely covered to the desired thickness, the mandrel is placed in an oven to solidify (set or cure) the resin. Once the resin has cured, the mandrel is removed, leaving the hollow billet.

Filament winding is well suited to automation, where the tension on the filaments can be carefully controlled. Filaments that are applied with high tension results in a final product with higher rigidity and strength; lower tension results in more flexibility. The orientation of the filaments can also be carefully controlled, so that successive layers are plied or oriented differently from the previous layer. The angle at which the fiber is laid down will determine the properties of the final product. A high angle “hoop” 90° will provide crush strength, while a lower angle pattern, 0°, (known as a closed or helical) provide greater tensile strength, shown in FIG. 3.

The simplest winding machines have two axes of motion, the mandrel rotation and the carriage travel (usually horizontal). Two axis machines are best suited to the manufacture of pipes. For pressure vessels such as LPG or CNG containers (for example) it is normal to have a four axis winding machine. A four-axis machine additionally has a radial (cross-feed) axis perpendicular to carriage travel and a rotating fiber payout head mounted to the cross-feed axis. The head rotation can be used to stop the fiber band twisting and thus varying in width during winding.

Filament winding can also be described as the manufacture of parts with high fiber volume fractions and controlled fiber orientation. Conventionally, fiber tows are immersed in a resin bath where they are coated with low or medium molecular weight reactants (such as a resin). The impregnated tows are then literally wound around a mandrel (mold core) in a controlled pattern to form the shape of the part. After winding, the resin is then cured, typically using heat. The mold core may be removed or may be left as an integral component of the part.

This process is primarily used for hollow, generally circular or oval sectioned components, such as pipes and tanks. Pressure vessels, pipes and drive shafts have all been manufactured using filament winding. It has been combined with other fiber application methods such as hand layup, pultrusion, and braiding. Compaction is through fiber tension and resin content is primarily metered.

The fibers may be impregnated with resin before winding (wet winding), pre-impregnated (dry winding) or post-impregnated. Wet winding is able to use low-cost materials with long storage life and relatively low viscosity. The pre-impregnated systems produce parts with more consistent resin content and can often be wound faster.

Glass fiber is the fiber most frequently used for filament winding, carbon fibers, aramid fibers, basalt fibers, and boron fibers are also used. Most high strength critical aerospace structures are produced with epoxy resins, with either vinylester or cheaper polyester resins being specified for most other applications. Other than epoxy resins, polyester resins, vinylester resins, and phenolic resins may also be used for filament winding. After the fibers are wound and the resins impregnated, the resulting component is normally cured at high temperature before removing the mandrel. Finishing operations include machining or grinding. In some cases, finishing operations are not needed to produce the final products.

Filament winding is currently being used to produce products such as golf clubs, pipes, oars, bicycle forks, power and transmission poles, pressure vessels, missile casings, aircraft fuselages, lamp posts and yacht masts. There is continuing interest in developing methods and apparatus for a filament winding process.

### BRIEF SUMMARY OF THE INVENTION

A filament winding method and system without needing a resin dip bath are disclosed. The method comprises feeding a fiber band of a plurality of fibers onto a mandrel without dipping the fibers in a resin bath, and applying a resin onto the fiber band at or about where the fiber band contacts the mandrel or applied directly to the fiber band and then wound onto the mandrel so that the resin is between the mandrel and the fiber band at the point of contact. In some embodiments, the resin can be sprayed onto the fibers and in other embodiments, the resin can be delivered in at least one layer, such as a bead, onto the fiber band that is then impregnated into the fiber band as the fiber band wraps around the mandrel. The fiber can comprise carbon fiber, basalt fiber, glass fibers, Kevlar fiber, polyester fiber, other fibers, or a combination thereof.

In an embodiment, the resin comprises without limitation polyester resin, vinylester resin, epoxy resin, phenolic resin, BMI resin, polyurethane resin, cyanate ester resin, or a compatible combination thereof.

In an embodiment, the method comprises utilizing an injection pump to apply the resin. In an embodiment, the method comprises controlling the flow rate of the injection pump to apply the resin. In an embodiment, the injection pump is integrated with the filament winder. In an embodiment, the injection pump is integrate with filament winder via a programmable logic controller or a variable frequency drive.

In an embodiment, the fiber is fed on the mandrel at an angle of from about 25° to 90°, advantageously 25° to 65°, and more advantageously 45°, wherein the angle is defined as the angle between the fiber and a horizontal plane when the mandrel is placed horizontally. In an embodiment, the method comprises controlling the flow rate of resin while applying the resin. In an embodiment, the flow rate of resin is controlled by a flow control valve. In an embodiment, the method further comprises controlling the speed at which the fiber is wound onto the mandrel and controlling the flow rate of resin while applying the resin. In an embodiment, the method comprises coordinating the speed at which the fiber is wound onto the mandrel and the flow rate of resin being applied to the fiber such that a proper amount of resin is applied to the fiber.

In an embodiment, the resin is maintained at a predetermined temperature. In embodiments, the predetermined temperature is from about ambient to about 170° F.

Further disclosed are parts made according to the method of this disclosure. Such parts include bridge or frac plug mandrels, wedges, sleeves, noses, cones, mule shoes, extrusion limiters, or tubular parts.

In at least one embodiment, the method for a filament winding comprises feeding a fiber band of rovings toward a mandrel without dipping the fiber in a resin bath; applying a resin onto the fiber band, the fiber band having a fiber band width; winding the fiber band with the resin onto the mandrel with the resin disposed between the mandrel and the fiber band at a point of contact between the fiber band and the mandrel; and compressing the resin into the fiber band as the resin and fiber band are wound onto the mandrel.

In another embodiment, a filament winding system without a resin dip bath is described. The system comprises a filament winder comprising a mandrel; and a resin applicator; wherein the filament winder and resin applicator are configured such that when a fiber is wound onto the mandrel, the resin applicator applies a resin to the fiber at or about the point where the fiber contacts the mandrel.

In at least one embodiment, a filament winding system without a resin dip bath is described. The system comprises a filament winder comprising a mandrel; and a resin applicator; wherein the filament winder and resin applicator are configured to apply a resin to a fiber band having a fiber band width with the resin disposed between the mandrel and the fiber band at a point of contact between the fiber band and the mandrel, and the resin is compressed into the fiber band as the resin and fiber band are wound onto the mandrel.

In an embodiment, the system further comprises a resin pump or flow control valve fluidly connected to the resin applicator. In an embodiment, the resin pump or flow control valve controls the flow rate of resin applied to the fiber. In an embodiment, the resin pump is integrated with the filament winder such that the speed at which the fiber is wound onto the mandrel and the flow rate of resin being applied to the fiber are coordinated. In an embodiment, the coordination between the speed at which the fiber is wound onto the mandrel and the flow rate of resin being applied to the fiber ensures that a proper amount of resin is applied to the fiber.

In an embodiment, the resin reservoir is maintained at a predetermined temperature. In an embodiment, the resin applicator can include a resin pump, injector, dropper, nozzle, or other dispenser for resin.

In an embodiment, the filament winder is configured such that fiber is fed onto the mandrel at an angle of from about 25° to 90°, wherein the angle is defined as the angle between the fiber and a horizontal plane when the mandrel is placed horizontally.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE SEVERAL VIEWS OF THE DRAWINGS

FIG. 1 illustrates a process of resin film infusion during filament winding, according to certain embodiments of this disclosure.

FIG. 2 is a 2D projection (side view) of the resin film infusion process as illustrated in

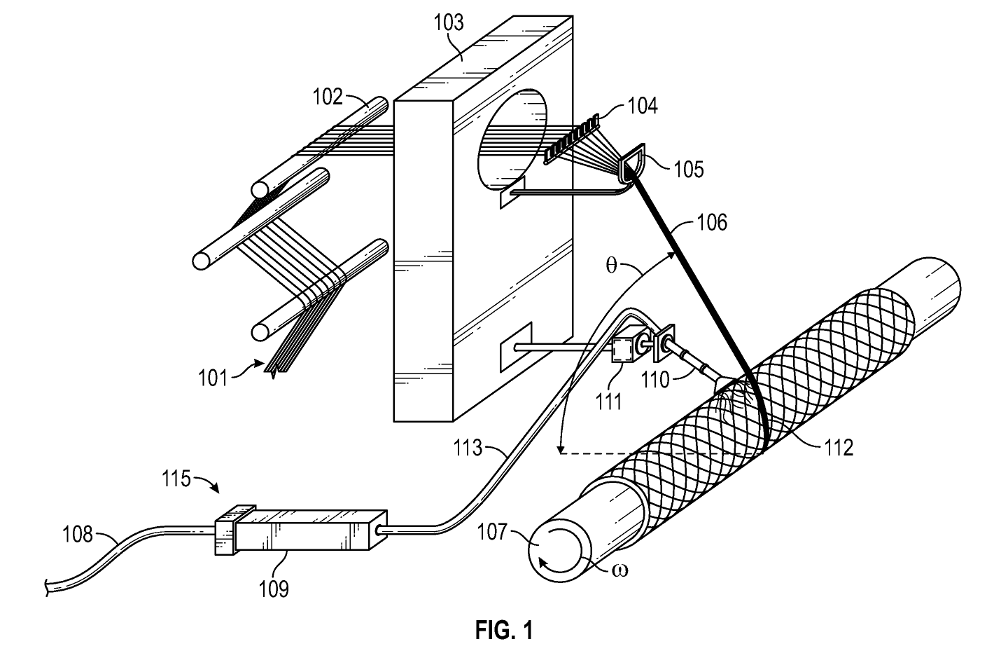

FIG. 1, according to certain embodiments of this disclosure.

FIG. 3 is a schematic illustration of the orientation in which the fibers are applied to the mandrel, according to certain embodiments of this disclosure.

FIG. 4 illustrates an alternative process of resin film infusion during filament winding, is according to certain embodiments of this disclosure.

FIG. 5 is a 2D projection (side view) of the resin film infusion alternative process as illustrated in FIG. 4, according to certain embodiments of this disclosure.

FIG. 6 illustrates an alternative process of resin film infusion during filament winding, according to certain embodiments of this disclosure.

FIG. 7 is a 2D projection (side view) of the resin film infusion alternative process as illustrated in FIG. 6, according to certain embodiments of this disclosure.

FIG. 8 illustrates an enlarged view of a fiber band of rovings with resin applied thereto in the process of resin film infusion during filament winding, according to certain embodiments of this disclosure.

FIG. 9 illustrates an enlarged view of a fiber band of rovings with resin applied thereto in the process of resin film infusion during filament winding, according to certain embodiments of this disclosure.

### DETAILED DESCRIPTION

The Figures described above and the written description of specific structures and functions below are not presented to limit the scope of what Applicant has invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present disclosure may require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation or location, or with time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a,” is not intended as limiting of the number of items. Further, the various methods and embodiments of the system can be included in combination with each other to produce variations of the disclosed methods and embodiments. Discussion of singular elements can include plural elements and vice-versa. References to at least one item may include one or more items. Also, various aspects of the embodiments could be used in conjunction with each other to accomplish the understood goals of the disclosure.

Certain terms are used throughout the following description and claims to refer to particular system components. This document does not intend to distinguish between components that differ in name but not function. In the following discussion and in the claims, the terms “including” and “comprising” are used in an open-ended fashion, and thus should be interpreted to mean “including, but not limited to”.

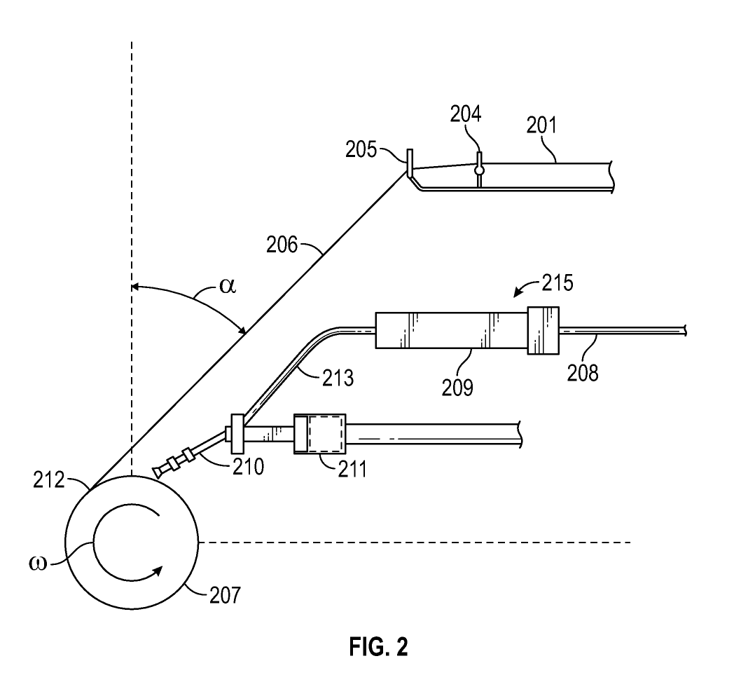

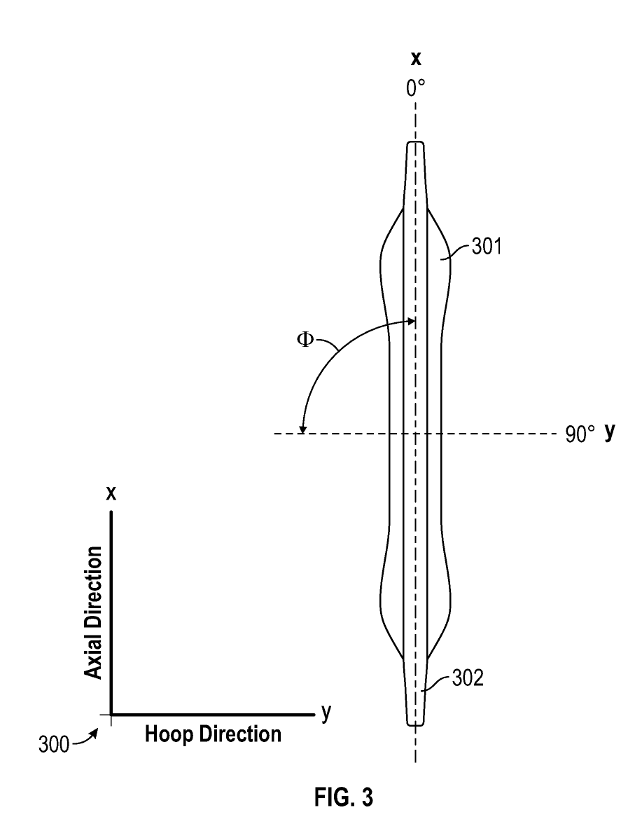

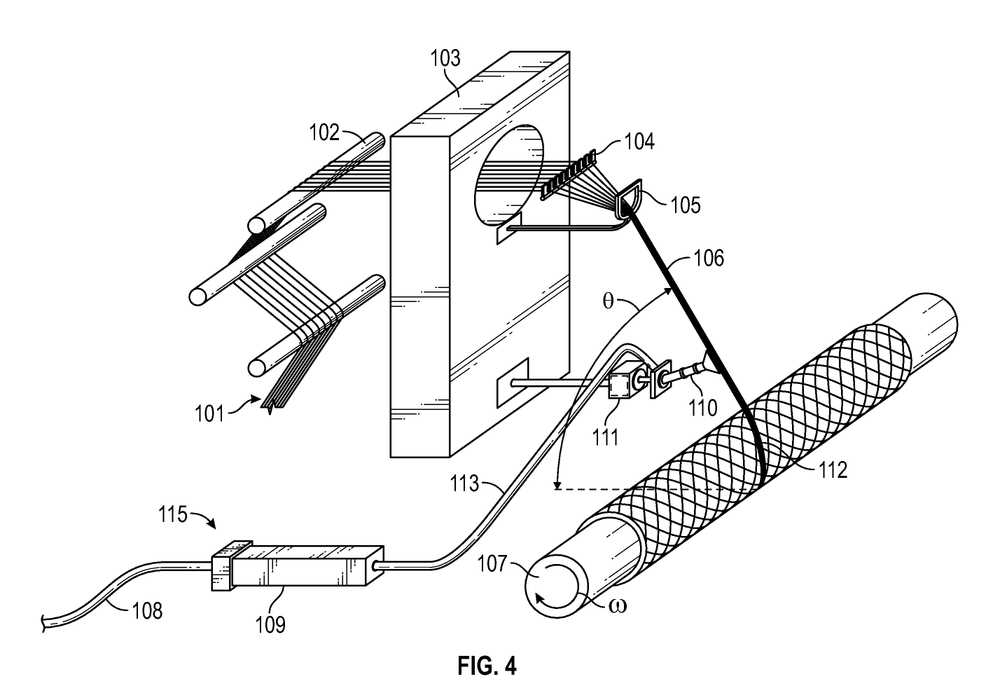

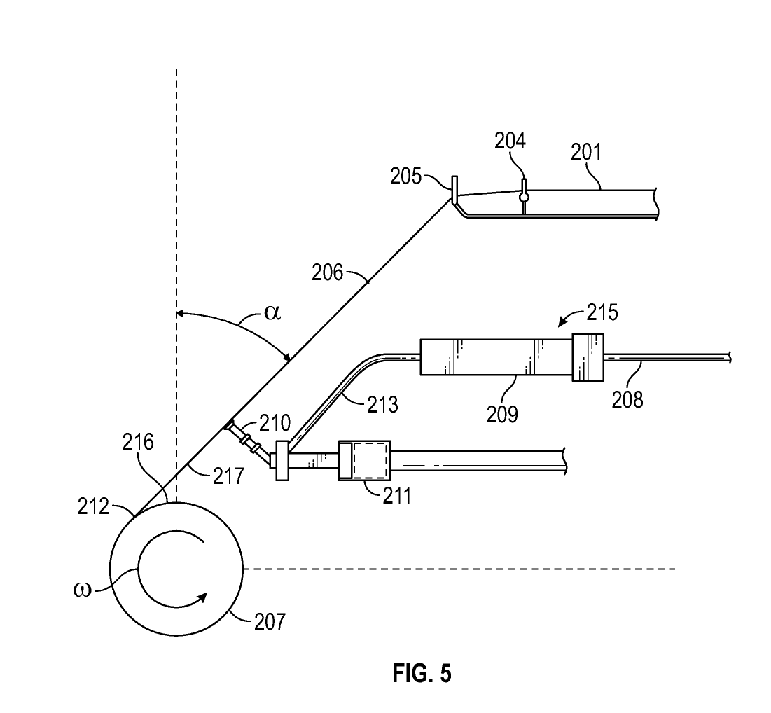

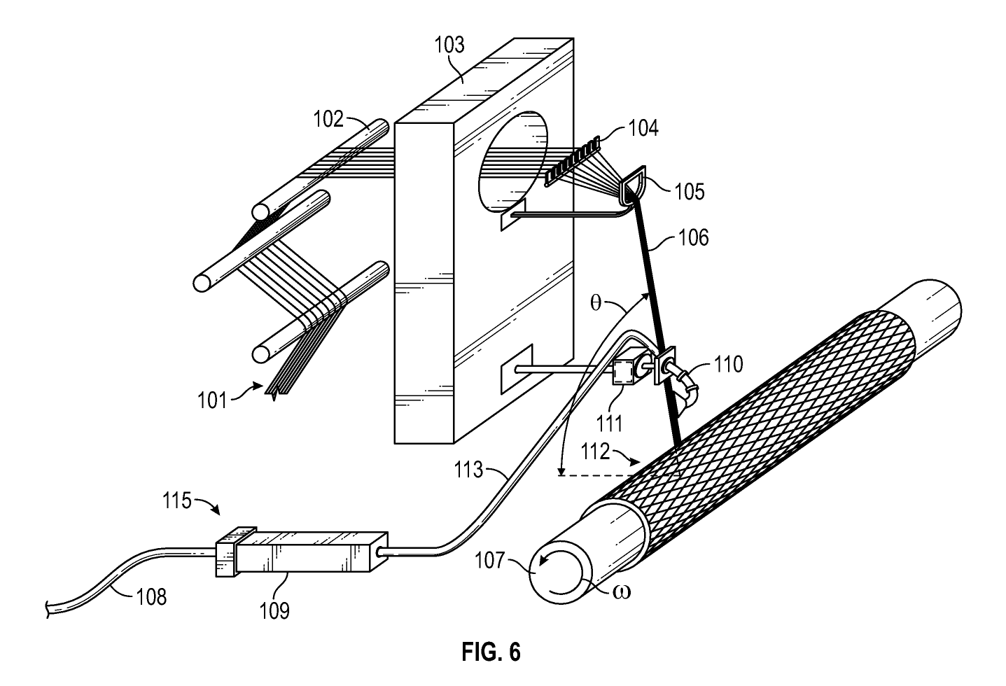

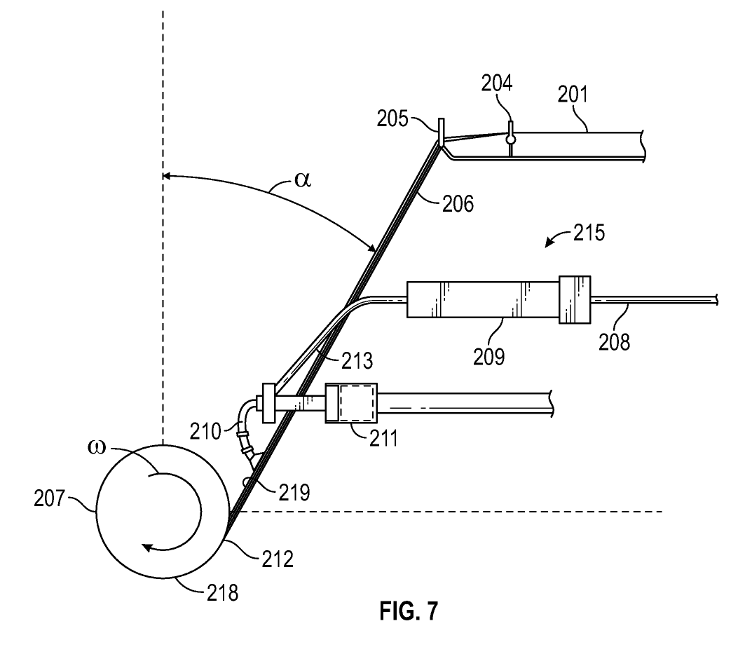

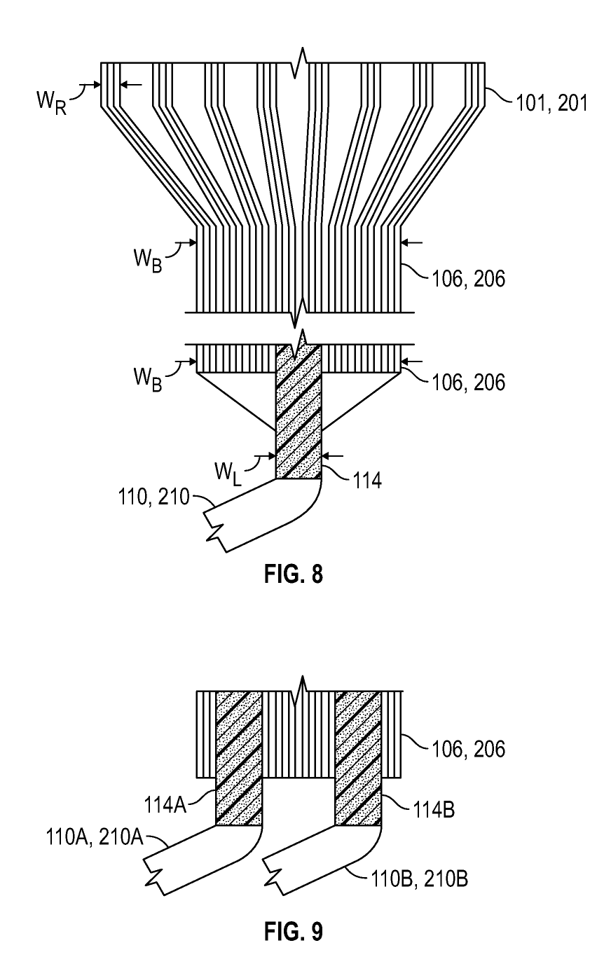

Overview. The filament winding method and system as disclosed herein eliminates the need for a dip bath that is used in traditional filament winding. Briefly, the fiber (e-glass, carbon, basalt, S-glass, etc.) can be fed on the mandrel at an approximately 45° angle (with a range from 25° to about 90°) and the resin is injected/applied at or about the point of contact with the mandrel (e.g., 112 in FIG. 1 or 212 in FIG. 2) or applied directly to the fiber and then wound onto the mandrel so that the resin is between the mandrel and the fibers at or about the point of contact (FIGS. 4-7). In some embodiments, the resin can be sprayed onto the fibers and in other embodiments, the resin can be delivered as a bead onto the fibers that are then impregnated into the fibers as resin is compressed between the fibers wrapping around the mandrel. Detailed description of such method and system is provided below.

Filament winding system. In an embodiment, a filament winding system comprises a filament winder and a resin applicator fluidly connected to a resin reservoir (not shown). As illustrated in FIG. 1, the filament winder comprises mandrel 107, fiber doffs (not shown) connected through fiber rovings 101, tension rods 102, boom 103, comb 104, and eye 105. The fiber rovings 101 are collected by the eye 105 into a fiber band 106 of rovings during the filament winding process. Other parts of the filament winder are known in the art and may be included in the system of this disclosure.

In an embodiment, a resin applicator 115 can include one or more of the following components: a hose or tube 108 that connects a resin reservoir (not shown) to a resin pump 109, a feed line 113 that connects the resin pump to a resin dispensing tube 110. The term “resin pump” is used broadly and can be a pump, injector, dropper, nozzle, or other dispenser for resin.

In FIG. 1, 111 represents a controller that can include a servo or mechanical device that places the resin applicator at or about the point of interest, where the fiber band of rovings meets the mandrel at the point of contact 112 between the fiber band and the mandrel.

In an embodiment, the filament winder and resin applicator are configured such that when a fiber is wound onto the mandrel, the resin applicator applies a resin to the fiber at or about the point of contact 112, where the fiber contacts the mandrel. In another embodiment, the resin applicator can apply resin to the fiber so that the resin is between the mandrel and the fibers at or about the point of contact.

Referring to FIG. 1, when the mandrel is placed horizontally, angle θ is defined as the angle between the fiber and a horizontal plane. In some embodiments, angle θ is in the range of from about 25° to 90°.

FIG. 2 is a 2D projection (side view) of the resin film infusion process as illustrated in FIG. 1. Angle α is defined as the angle between the fiber and a vertical plane when the mandrel is placed horizontally. And thus α+θ=90°. In FIG. 2, 206 represents a fiber band of rovings; 207 represents the mandrel of the filament winder; 204 represents the comb; and 205 represents the eye. 210 represents the resin dispensing tube of the resin applicator; 209 represents the resin pump; and 208 represents the hose or tube that connects the resin pump 209 to a resin reservoir (not shown). 211 represents the controller that controls the movement of the application head. 212 represents the contact point where the fiber band of rovings meets the mandrel. 213 represents the feed line that connects the resin pump 209 to the resin dispensing tube 210. 215 represents the resin applicator. In an embodiment, the resin applicator 215 can include one or more of the following components: the hose or tube 108, the resin pump 109, the feed line 213, and the resin dispensing tube 110.

In FIG. 3, x axis is the length along the mandrel or part being made. The y axis is the direction perpendicular to the mandrel/part, e.g., the hoop, 301 represents the part. 302 is the mandrel on which the part is being wrapped. 300 represents the coordinate system of the x and y axes. 1 is the angle between the x and y axes.

The filament winding system can include the resin pump 209 fluidly connected to the resin reservoir. In an embodiment, the resin pump 209 provides the flow rate of resin applied to the fiber and can be controlled by the controller 211. In some cases, the control of the resin pump is integrated with the filament winder, such that the speed at which the fiber is wound onto the mandrel and the flow rate of resin being applied to the fiber are coordinated. In an embodiment, a signal is sent from the filament winder to the controller, which signal is configured to cause adjustment of the flow rate of resin based on the speed at which the mandrel is rotating. In an embodiment, the controller 211 is integrated with a programmable logic controller (PLC) or variable frequency device (VFD) to coordinate the flow rate of resin and the rotation speed of the mandrel. The controller 211 may also control a servo or mechanical device that guides the resin applicator 215 to the contact point of application (112 in FIG. 1 or 212 in FIG. 2). In some embodiments, the coordination between the speed at which the fiber is wound onto the mandrel and the flow rate of resin being applied to the fiber helps ensure that a proper amount of resin is applied to the fiber. This way, the amount of resin wasted is reduced or minimized.

In an embodiment, the filament winding system of this disclosure comprises a heater for the resin reservoir, such that the resin reservoir is maintained at a predetermined temperature. This predetermined temperature depends on the type of resin used. In some cases, it is room temperature. In other cases, this predetermined temperature is in the range of from about ambient to about 170° F.

FIG. 4 illustrates an alternative process of resin film infusion during filament winding, according to certain embodiments of this disclosure. FIG. 5 is a 2D projection (side view) of the resin film infusion alternative process as illustrated in FIG. 4, according to certain embodiments of this disclosure. The components have been described above in FIGS. 1 and 2. In general, the fiber rovings 101, 201 pass over the tension rods 102, through the boom 103, and through the comb 104, 204 to be combined into a fiber band 106, 206 through the eye 105, 205 and wound onto the mandrel 107, 207. In this embodiment, the resin applicator 115, 215 applies resin to the fiber band prior to the point of contact 112, 212 so that the resin is between the fiber band and the mandrel at the point of contact. The resin is applied to a surface of the fiber band that will contact the mandrel. For example, if the fiber band is wound onto a top surface 216 of the mandrel, as shown in FIGS. 4 and 5, then the resin will be applied to a bottom surface 217 of the fiber band. As the fiber band is wound onto the mandrel, the resin that is disposed between the fiber band and the mandrel will become compressed between the fiber band and mandrel and impregnate into the fiber band between the fibers.

FIG. 6 illustrates an alternative process of resin film infusion during filament winding, according to certain embodiments of this disclosure. FIG. 7 is a 2D projection (side view) of the resin film infusion alternative process as illustrated in FIG. 6, according to certain embodiments of this disclosure. The components have been described above in FIGS. 1 and 2 and 4 and 5. In this embodiment, the resin applicator 115, 215 applies resin to the fiber band prior to the point of contact 112, 212 so that the resin is between the fiber band and the mandrel at the point of contact. The resin is applied to a surface of the fiber band that will contact the mandrel. For example, if the fiber band is wound onto a bottom surface 218 of the mandrel, as shown in FIGS. 6 and 7, then the resin will be applied to a top surface 219 of the fiber band. As the fiber band is wound onto the mandrel, the resin that is disposed between the fiber band and the mandrel will become compressed between the fiber band and mandrel.

The orientations of the mandrel, fiber band, and resin applicator are illustrative and relative to the function of the components in light of the description herein. If the orientation of the mandrel were to be varied, then respective surfaces and orientations could change to accommodate the relative functioning of the other components. Therefore, the terms “bottom” and “top” are to be interpreted relative to the orientations of the mandrel and the fiber band, where the relative orientations may vary in absolute orientations.

FIG. 8 illustrates an enlarged view of a fiber band of rovings with resin applied thereto in the process of resin film infusion during filament winding, according to certain embodiments of this disclosure. The fiber rovings 101 are generally composed of individual fibers. For example, commercially available fibers rovings can have a roving width W_{R} of about ⅛ of an inch wide. As described above, the fiber rovings 101 can pass through an eye 105, 205 to be combined into a fiber band 106, 206. For example, eight fiber rovings, each being about ⅛ of an inch wide, can be combined into a fiber band having a fiber band width W_{B} of about ½ inch wide. A layer of resin 114 can be applied through the resin dispensing tube 110, 210 to the fiber band. The layer of resin 114 can be a bead or spray and can have a layer width W_{L}. The term “bead” is used broadly to apply to any form of deposition of the resin that is not sprayed, including a continuous or periodically interrupted stream, drops, or other forms. In general, the resin layer should be sufficiently thick and wide, so that when the resin is compressed between the mandrel and the fiber band, the layer of resin has sufficient volume to flow in between the fibers of the fiber band to impregnate the fiber band. If the layer width W_{L} is less than the fiber band width W_{B}, then the layer volume should be sufficiently thick to spread across the fiber band when compressed. Without limitation and for illustrative purposes, experimental data has shown that a layer of resin with commercial consistency to form a thickness commensurate with its width can have a layer width W_{L} of at least ⅙ of the fiber band width W_{B} (that is, a 1:6 ratio or greater, such as and without limitation 1:5, 1:4, 1:3, 1:2, 1:1, and any fractional increment therebetween) for commercially acceptable results.

FIG. 9 illustrates an enlarged view of a fiber band of rovings with resin applied thereto in the process of resin film infusion during filament winding, according to certain embodiments of this disclosure. Similar to FIG. 8, the fiber band 106, 206 can have a layer of resin 114 applied thereto. However, the layer 114 can be separated into individual layer portions 114A, 114B. In some embodiments, the separated portions may aid in spreading the resin across the fiber band. In such embodiments, the combined width W_{L} of the layer portions can form a suitable ratio with the fiber band width W_{B}. In the example provided above for FIG. 8, the combined layer width W_{L} of the layer portions 114A, 114B could be at least ⅙ of the bandwidth W_{B}.

Filament winding method. In an embodiment, a filament winding method comprises feeding a fiber on a mandrel; and applying a resin onto the fiber at or about the point of where the fiber contacts the mandrel. FIG. 1 illustrates this process. In various embodiments, the fiber comprises without limitation, carbon fiber, basalt fiber, S-glass fiber, S-2 glass fiber, A-glass fiber, C-glass fiber, E-glass fiber, D-glass fiber, Kevlar fiber, ECR glass fiber, polymeric fiber, or a combination thereof.

In various embodiments, the resin comprises without limitation polyester resin, vinylester resin, epoxy resin, phenolic resin, BMI resin, polyurethane resin, cyanate ester resin, or a compatible combination thereof.

In an embodiment, a resin applicator such as an injection pump is used to apply the resin onto the fiber. In some cases, the resin applicator is integrated with the filament winder.

In an embodiment, the fiber is fed on the mandrel at an angle θ of from about 25° to 90°, wherein said angle θ is defined as the angle between the fiber and a horizontal plane when the mandrel is placed horizontally.

In some embodiments, the flow rate of resin is controlled, for example, by the resin applicator 215 or controller 211 that can include a PLC or a variable frequency drive (VFD).

In an embodiment, the speed at which the fiber is wound onto the mandrel is controlled, for example, by controlling the rotation speed of the mandrel.

In an embodiment, the speed at which the fiber is wound onto the mandrel and the flow rate of resin being applied are both controlled. In a further embodiment, the speed at which the fiber is wound onto the mandrel and the flow rate of resin being applied to the fiber are coordinated such that a proper amount of resin is applied to the fiber. The direction of rotation w of the mandrel is generally away from an entry direction of the fibers, so as to pull the fibers onto the mandrel. For example in FIG. 1, the fiber band entry is from the left of the mandrel onto the top surface of the mandrel. Thus, the mandrel rotates in a clockwise direction ω, so that the top surface of the mandrel is rotating to the right, away from the fiber band entry from the left to pull the fiber band onto the mandrel to wind around the mandrel. In FIG. 6, the fiber band entry is from the left of the mandrel but onto the bottom surface of the mandrel. Thus, the mandrel rotates in a counterclockwise direction ω, so that the bottom surface of the mandrel is rotating to the right, away from the fiber band entry from the left to pull the fiber band onto the mandrel to wind around the mandrel.

In some embodiments, the resin is kept at a predetermined temperature. In some embodiments, the resin is kept at this predetermined temperature by maintaining the temperature of the resin reservoir. In some cases, this predetermined temperature is room temperature. In some cases, this predetermined temperature is from ambient to about 170° F.

After the part is made by the filament winder, the part may be cured by any means as known to one skilled in the art. For example, the part is put in an oven and rotated until curing is completed as desired.

FIGS. 4 and 5 illustrate an alternative process. The components have been described above. In at least this embodiment, the resin can be applied to the fiber band 106, 206 generally prior to contact of the band with the mandrel 107, 207. The resin can be applied to the band by spraying, dropping, depositing onto the surface of the fiber band, or other dispensing methods. The resin is applied in a manner, so that at the point of contact between the fiber band and the mandrel, the resin is disposed between the mandrel and the fiber band. Thus, the resin is compressed and forced into the fiber band to impregnate fibers, as the fiber band is wound onto the mandrel. If the resin is applied in a localized area of the band, such as with a bead at less than the full width of the fiber band, the compression of the resin between the mandrel and the fiber band helps spread the resin across the width of the fiber band, as described in reference to FIGS. 8 and 9 above.

For example, if the mandrel is generally aligned horizontally, and the fiber band is wound onto a top surface 216 of the mandrel, then the resin would be applied to a bottom surface 217 of the fiber band prior to a point of contact 212 of that portion of the fiber band with the mandrel. As the fiber band with the resin is wound around the mandrel, the resin is compressed between the mandrel and the fiber band and is impregnated between the fibers of the fiber band on the mandrel.

FIGS. 6 and 7 illustrate another alternative process. The components have been described above. In FIGS. 6 and 7, the fiber band entry is from the left of the mandrel onto the bottom surface 218 of the mandrel. The resin can be applied to the top surface 219 of the fiber band 106, 206 prior to contact of that portion of the fiber band with the mandrel 107, 207, so that the resin is disposed between the mandrel and the fiber band at the point of contact 212 between the fiber band and the mandrel. The resin is compressed and forced between the fibers of the fiber band, as the fiber band is wound onto the mandrel.

Parts and products made by filament winding. In various embodiments, the filament winding method and system as described herein produce bridge or frac plug mandrels, wedges, sleeves, noses, cones, mule shoes, extrusion limiters, or any tubular parts. As one killed in the art would recognize, these parts are not differentiated by name but only by function.

Advantages. In certain embodiments, the resin injection pump is integrated with the filament winder and controls the flow rate of the resin, thus reducing the amount of resin wasted. In certain embodiments, the resin flow rate and the fiber winding speed are coordinated to ensure that a proper amount of resin is applied to the fiber. In various embodiments, the need for a resin bath is eliminated.

While preferred embodiments of the invention have been shown and described, modifications thereof can be made by one skilled in the art without departing from the spirit and teachings of the invention. The embodiments described herein are some only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, and so forth). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an is embodiment of the present invention. Thus, the claims are a further description and are an addition to the expressly described embodiments of the present invention. The disclosures of all patents, patent applications, and publications cited herein are hereby incorporated by reference, to the extent they provide some, procedural or other details supplementary to those set forth herein.

The order of steps can occur in a variety of sequences unless otherwise specifically limited. The various steps described herein can be combined with other steps, interlineated with the stated steps, and/or split into multiple steps. Some elements are nominated by a device name for simplicity and would be understood to include a system with related components that are known to those with ordinary skill in the art and may not be specifically described. Similarly, elements have been described functionally and can be embodied as separate components or can be combined into components having multiple functions.

Other and further embodiments utilizing one or more aspects of the inventions described above can be devised without departing from the disclosed invention as defined in the claims. For example, the size, relative positions of components, additional components, number of fiber rovings and bands of rovings, and other variations can occur in keeping within the scope of the claims. Other embodiments have been contemplated.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intends to protect fully all such modifications and improvements that come within the scope or range of equivalents of the following claims.

What is claimed is:

1. A filament winding method, the method comprising
feeding a fiber band of rovings toward a mandrel without dipping the fiber in a resin bath;
applying a resin onto the fiber band, the fiber band having a fiber band width;
winding the fiber band with the resin onto the mandrel with the resin disposed between the mandrel and the fiber band at a point of contact between the fiber band and the mandrel; and
compressing the resin into the fiber band as the resin and fiber band are wound onto the mandrel.

2. The method of claim 1, wherein winding the fiber band with the resin onto the mandrel with the resin disposed between the mandrel and the fibers at the point of contact comprises rotating the mandrel in a direction that is away from the entry direction of the fibers

3. The method of claim 2, wherein applying the resin to the fiber band comprises applying the resin onto a top surface of the fiber band if the fiber band is winding onto the mandrel from a bottom surface of the mandrel.

4. The method of claim 2, wherein applying the resin to the fiber band comprises applying the resin onto a bottom surface of the fiber band if the fiber band is winding onto the mandrel from a top surface of the mandrel.

5. The method of claim 1, wherein applying the resin onto the fiber band comprises applying a layer of resin having a layer width onto the fiber band.

6. The method of claim 5, wherein applying a layer of resin onto the fiber band comprises applying the resin with a layer width:fiber band width ratio of at least 1:6.

7. The method of claim 1, wherein the layer of resin comprises a plurality of layer portions, each portion having a width, and wherein applying the resin onto the fiber band comprises applying the plurality of layer portions onto the fiber band.

8. The method of claim 7, wherein the widths of the plurality of layer portions establishes a combined layer width, and wherein applying the plurality of layer portions of resin onto the fiber band comprises applying the resin with a combined layer width:fiber band width ratio of at least 1:6.

9. The method of claim 1 wherein said fiber comprises carbon fiber, basalt fiber, S-glass fiber, S-2 glass fiber, A-glass fiber, C-glass fiber, E-glass fiber, D-glass fiber, Kevlar fiber, ECR glass fiber, or polyester fiber, or a combination thereof.

10. The method of claim 1 wherein said resin comprises polyester resin, vinylester resin, epoxy resin, phenolic resin, BMI resin, polyurethane resin, cyanate ester resin, or a compatible combination thereof.

11. The method of claim 1 wherein said fiber is fed on the mandrel at an angle of from about 25° to 90°, wherein said angle is defined as the angle between the fiber and a horizontal plane when the mandrel is placed horizontally.

12. A part made according to the method of claim 1.

13. A filament winding system without a resin dip bath comprising
a filament winder comprising a mandrel; and
a resin applicator;
wherein the filament winder and resin applicator are configured to apply a resin to a fiber band having a fiber band width with the resin disposed between the mandrel and the fiber band at a point of contact between the fiber band and the mandrel, and the resin is compressed into the fiber band as the resin and fiber band are wound onto the mandrel.

14. The system of claim 13, wherein the resin applicator is configured to apply layer of resin having a layer width onto the fiber band.

15. The system of claim 14, wherein the layer of resin has a layer width:fiber band width ratio of at least 1:6.

16. The system of claim 13, wherein the layer of resin comprises a plurality of layer portions, each portion having a width.

17. The system of claim 16, wherein the widths of the plurality of layer portions establishes a combined layer width with a combined layer width:fiber band width ratio of at least 1:6.

18. The system of claim 13, wherein said fiber comprises carbon fiber, basalt fiber, S-glass fiber, S-2 glass fiber, A-glass fiber, C-glass fiber, E-glass fiber, D-glass fiber, Kevlar fiber, ECR glass fiber, or polyester fiber, or a combination thereof.

19. The system of claim 13, wherein said resin comprises polyester resin, vinylester resin, epoxy resin, phenolic resin, BMI resin, polyurethane resin, cyanate ester resin, or a compatible combination thereof.

20. The system of claim 13, wherein said filament winder is configured such that fiber is fed onto the mandrel at an angle of from about 25° to 90°, wherein said angle is defined as the angle between the fiber and a horizontal plane when the mandrel is placed horizontally.
